(19) United States
(12) Patent Application Publication
(10) Pub. No.: US 2022/0106109 A1
(43) Pub. Date: Apr. 7, 2022

(54) PORTABLE CONTAINER FOR COLLECTING AND DISPOSING OF GARBAGE AND WASTE

(71) Applicants: Seth P. Polevoi, Riverton, UT (US); Jacob Davis, Riverton, UT (US)

(72) Inventors: Seth P. Polevoi, Riverton, UT (US); Jacob Davis, Riverton, UT (US)

(21) Appl. No.: 17/474,998

(22) Filed: Sep. 14, 2021

Related U.S. Application Data
(60) Provisional application No. 63/078,133, filed on Sep. 14, 2020.

(51) Int. Cl. B65F 1/00; A45F 3/04; A45F 3/00; A45F 3/02

(52) U.S. Cl. CPC B65F 1/0006; A45F 3/04; B65F 2210/167; A45F 3/02; A45F 2003/003; A45F 3/005

(57) ABSTRACT

Portable containers for people to provide cleanup activity while hiking, running, hunting, camping, enjoying snow sports, or otherwise enjoying the outdoors. The portable containers can stay substantially clean due to a water-resistant coating. The portable containers can include compact folding where the container can roll-up to carry the most trash with the least amount of space. The portable containers can be lightweight making it easy to carry for all outdoor adventures. The portable containers can enable cleanliness and convenience in a hands-free solution including a pull tab to open a top opening thereof. The portable container can include an elastic or inelastic cord tensioner and spring steel system used to keep the opening in an increased open area state for easy hands-free access to the interior. The portable container can include a bottom opening zipper for hands-free gravity enabled disposal of trash and waste held within the portable container.

### CROSS-REFERENCE TO RELATED APPLICAITON

This application claims the benefit of and priority to U.S. Provisional Patent Application 63/078,133 filed Sep. 14, 2020, the contents of which are hereby incorporated herein by reference in its entirety and for all purposes.

### BACKGROUND OF THE INVENTION

It is estimated that by 2050 the oceans will contain more plastics than fish, by weight. This is according to a 2016 report released by the World Economic Forum and Ellen MacArthur Foundation. Plastics take years to decay are injuring and killing marine life in a variety of ways. Many animals die either by choking, suffocation, or starvation as their stomachs fill with plastic they can't digest.

Likewise, toxins in marine life make their way into the human food chain. The same is true for garbage left behind in forests, or other areas, where wildlife search and scavenge for food. Moreover, landfills full of waste are releasing gases and pollutants into our atmosphere. Put simply, the environmental toll of pollution and waste is devastating.

Dog Plogging is a term that encourages dog owners to pick up litter while walking their dogs. “Plogging” is a concept originating from Sweden. Originally, a man encouraged joggers to pick up trash on their runs; and, the word plogging seemed to fit the activity. Plogging caught fire in Sweden and is being adopted by different groups around the world. Similarly, dog plogging has been growing among the regulars of dog parks and other cleanup groups. Some local businesses have been incentivizing dog plogging with gift cards, swag, and other rewards for participants. Likewise, there are sponsorships to help spread the word that a cleaner city benefits everyone.

It is important for everyone to get involved and “leave no trace”. People around the world are uniting in a mission to clean up our planet. From America to India, posts using the hashtag #trashtag can be found on social platforms. Before and after pics are being posted, showing what a difference picking up litter can make when people work together as a community, group, or COLONY TM to clean up trash and waste.

The inventors of this patent application built the portable trash, waste, and recycling containers disclosed herein on the idea that most people would clean-up litter and garbage if it was easy and practical to do so. The inventors envisioned a better world in which people do the same as bees and everyone contributes to a cleaner waste-free and trash-free world each time everyone in this community of concerned people go outside.

The subject matter claimed herein is not limited to embodiments that solve any disadvantages or that operate only in environments such as those described above. Rather, this background is only provided to illustrate one exemplary technology area where some embodiments described herein may be practiced.

### BRIEF DESCRITPION OF THE DRAWINGS

FIGS. 1 and 2, a portable container for collecting and disposing of garbage and waste;

FIGS. 3-5 illustrate a bottom opening and a bottom closure mechanism of the portable container enabling selective gravity enabled disposal of the garbage and waste through the bottom opening of the portable container;

FIG. 6 illustrates a magnetic closure mechanism of the portable container.

FIG. 7 illustrates some examples of readily available liner bags that may be suitable for use with the portable container;

FIG. 8 illustrates a magnetic liner securement mechanism;

FIG. 9 illustrates one or more foldable fabric flaps containing a magnetic and/or metallic element(s);

FIG. 10 illustrates a top opening expansion retention mechanism of the portable container;

FIGS. 11 and 12 illustrate a roll-top closure mechanism of the portable container;

FIGS. 13 and 14 illustrate a roll-bottom retention mechanism of the portable container;

FIGS. 15 and 16 illustrate a moisture impervious front pocket of the portable container;

FIGS. 17 and 18 illustrate one or more strap connectors coupled to the portable container;

FIG. 19 illustrates top Molly webbing of the portable container;

FIG. 20 illustrates different carrying configurations of the portable container; and

FIGS. 21 and 22 illustrate some examples of dimensions which may be suitable for components and aspects of the portable container.

### DETAILED DESCRIPTION

The inventors of this patent application developed the concepts behind these products while day-hiking with their family. They had been carrying empty plastic grocery bags to collect rubbish, but the utility of empty plastic grocery bags is limited, and are generally not biodegradable (so therefore exacerbates the problem). The inventors investigated various features, designs, and prototypes that would include a waterproof coating, include simple emptying processes, closures, portability, and versatility. Thus, the embodiments disclosed herein comprise components thereof as well as various combinations of the sub-combinations of elements, features, and aspects disclosed herein.

The innovative trash, waste, and recycling containers disclosed herein can be designed to accommodate the most common outdoor activities, for example the “day hike”. The inventors of this patent application hope that providing a durable, eco-friendly, and re-usable product that is easy to store in your car, for example, would be easier for people to provide cleanup activity while hiking, running, hunting, camping, enjoying snow sports, or otherwise enjoying the outdoors.

This portable container can put a large emphasis on being environmentally conscious. The portable container can be extremely durable with elements like 210D nylon for the main body, very strong nylon webbing for all the loops, and extra attention to seams and joint re-enforcement. According to certain design examples, the portable container can be 9.5 inches by 14 inches (24.1×35.6 cm) and hold 4.7 liters when closed and 6.6 liters while the top opening is open.

The portable container can stay substantially clean due to its water-resistant coating and can be repeatedly cleaned with a small wet towel or soapy water for spot cleaning. If deeper cleaning is needed the inside and outside of the portable container can be gently scrubbed with warm soapy water, for example.

The portable container can include various improvements and innovations over previous designs and inherently limited solutions. For example, the portable containers disclosed herein can include compact folding—the container can roll-up to carry the most trash with the least amount of space. The portable containers can be trail ready—leaving the trails better than previously experienced with disposable trash bags for messy jobs. The portable containers can be lightweight—the lightweight container makes it easy to carry for all outdoor adventures from sun to snow. Various designs disclosed hereinafter exhibit cleanliness and convenience all in one hands-free solution.

The portable container can include a pull tab to open a top opening thereof. The portable container can include an innovative elastic or inelastic cord tensioner and spring steel system used to keep the opening in an increased open area state for easy hands-free access to the interior of the portable container. To release the increased top opening state, a lockable fitting disposed around a reduced length of the tensioner can be released. Magnets incorporated proximate to the top opening of the portable container can retain the top opening in a closed state so as to retain bags of waste and trash therein.

The portable container can include a bottom opening zipper for hands-free gravity enabled disposal of trash and waste held within the portable container. Thus, collected rubbish can be easily disposed of by simply unzipping the bottom of portable container to drop garbage into a bin, bag, or garbage can.

The portable container can include adjustable sizing for various activities. A roll up strap can be included to conveniently size the portable container to a particular activity or amount of trash and waste temporarily stored therein. As the portable container is filled, roll-down adjustments can be made to hold as much trash and waste as needed. The portable container can be sized to fit common disposable and decomposable liner bags. As such, liquids and messy solids can be held therein without causing a full cleaning of the portable container.

In addition, a unique system for holding a top opening of a liner bag open is disclosed. As the liner bag is filled, a user can simply pull an edge out of a magnetic clasp, tie a knot in an end of the liner bag, and drop the filled liner bag down into an interior of the portable container.

One skilled in the art will appreciate in view of this disclosure that, for this and other apparatus, systems, processes and methods disclosed herein, the elements, components, and steps may be implemented in differing order. Moreover, the structures of apparatus may be reorganized or variated to accomplish a given feature or function. Furthermore, the outlined steps and operations are only provided as examples, and some of the steps and operations may be optional, combined into fewer steps and operations, or expanded into additional steps and operations without detracting from the essence of the disclosed embodiments.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

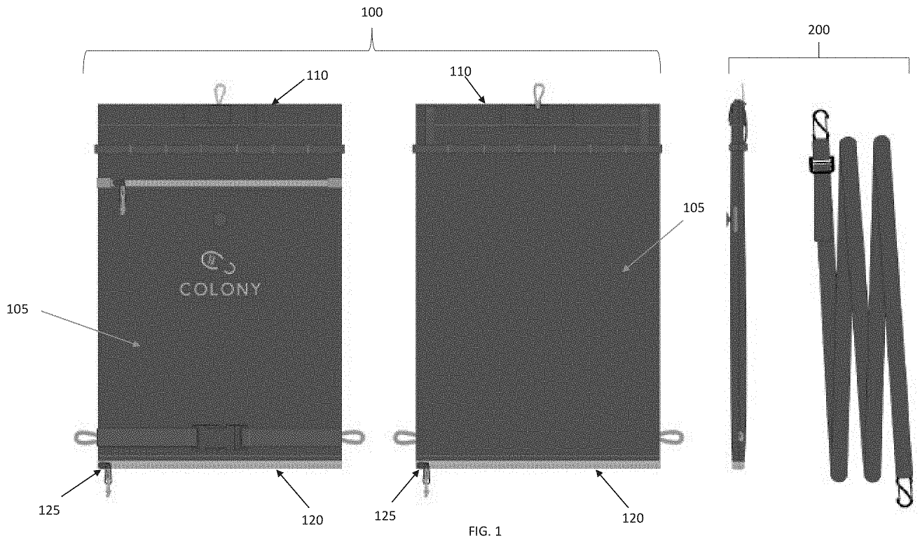

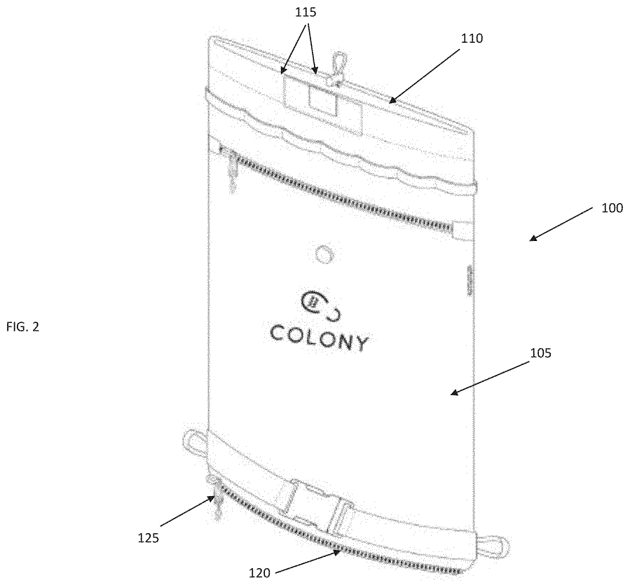

Referring to FIGS. 1 and 2, a portable container 100 for collecting and disposing of garbage and waste is illustrated along with a carrying strap 200 according to an example of the present invention. The portable container 100 includes container sidewalls 105 including a flexible moisture impervious fabric for containing and holding the garbage and waste when placed therein. The portable container 100 includes a top opening 110 and a bottom opening 120. The portable container 100 includes a top closure mechanism 115 for selective placement of the garbage and waste within the sidewalls 105 of the portable container 100.

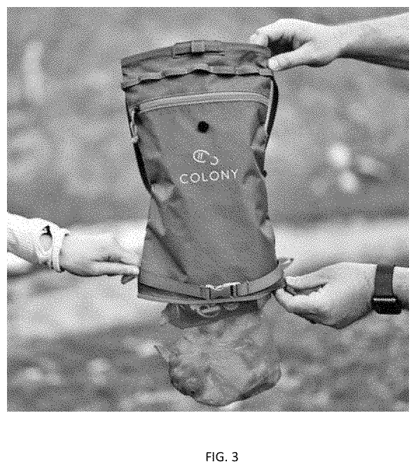

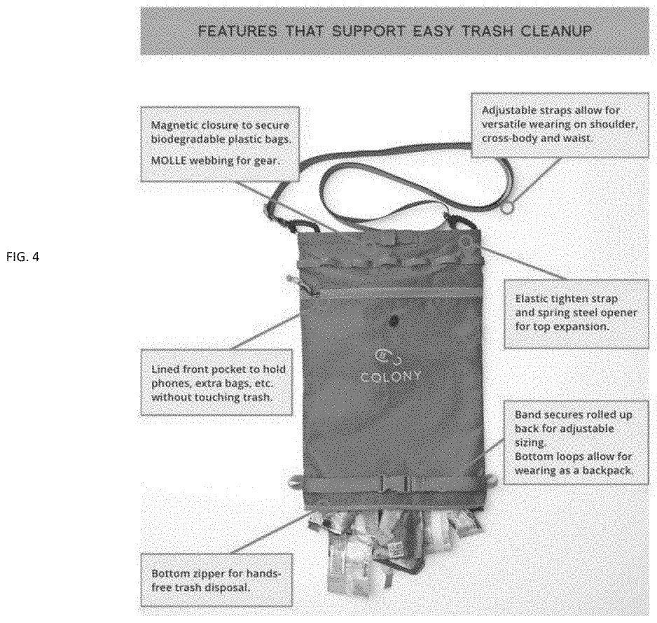

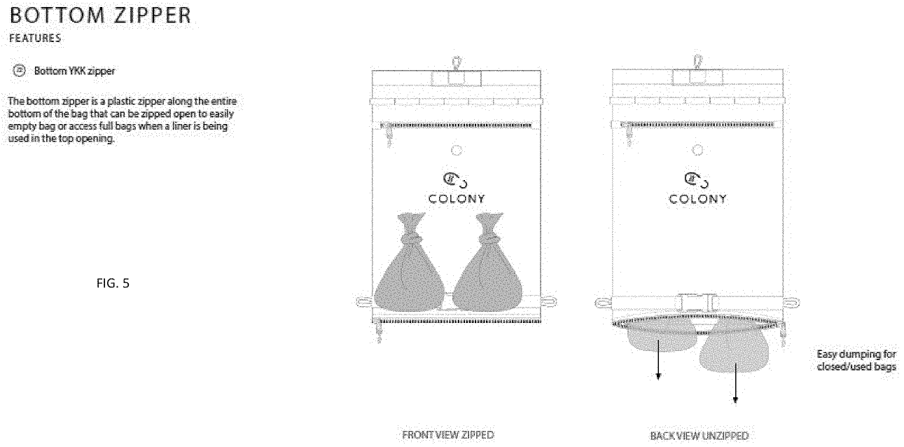

The portable container 100 further includes a bottom opening 120 and a bottom closure mechanism 125 disposed proximate to the bottom opening 120 and enabling selective gravity enabled disposal of the garbage and waste through the bottom opening 120 of the portable container 100 as illustrated in FIGS. 3-5. The bottom closure mechanism 125 can include a zipper extending across the bottom opening 120 as shown in FIGS. 1-5. And, the zipper can be substantially moisture impervious when disposed in a zipped and closed configuration.

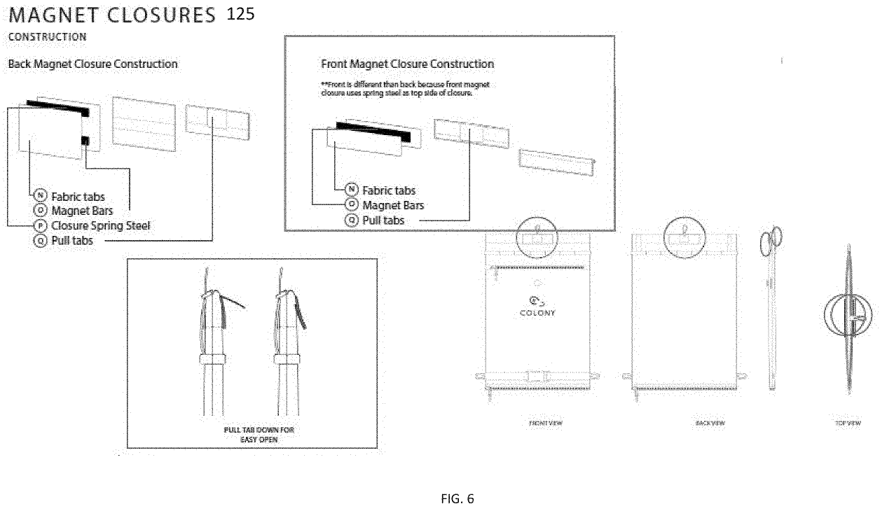

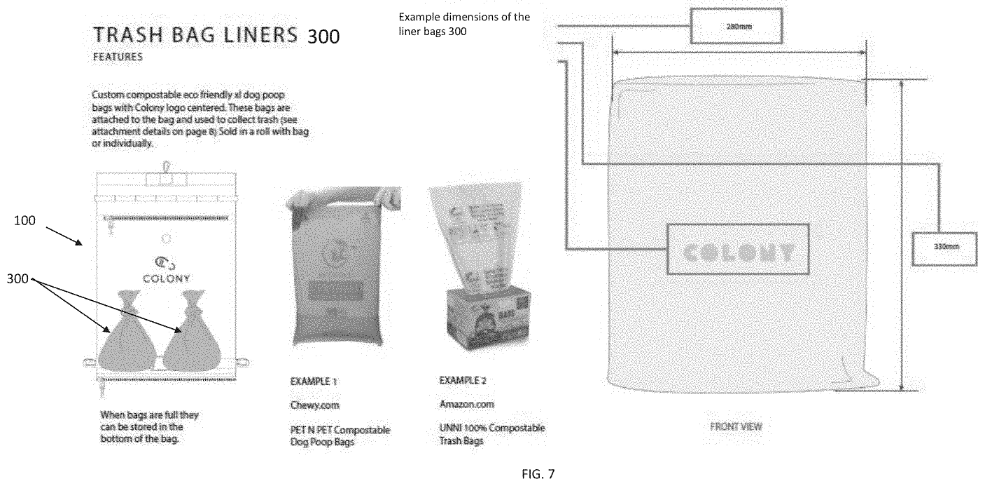

The top closure mechanism 125 can include a magnetic closure mechanism. For example, referring to FIG. 6, the magnetic closure mechanism 125 can include opposing magnetic elements and/or opposing magnetic and metallic elements. FIG. 7 illustrates some examples of readily available liner bags 300 that may be suitable for use with the portable container 100.

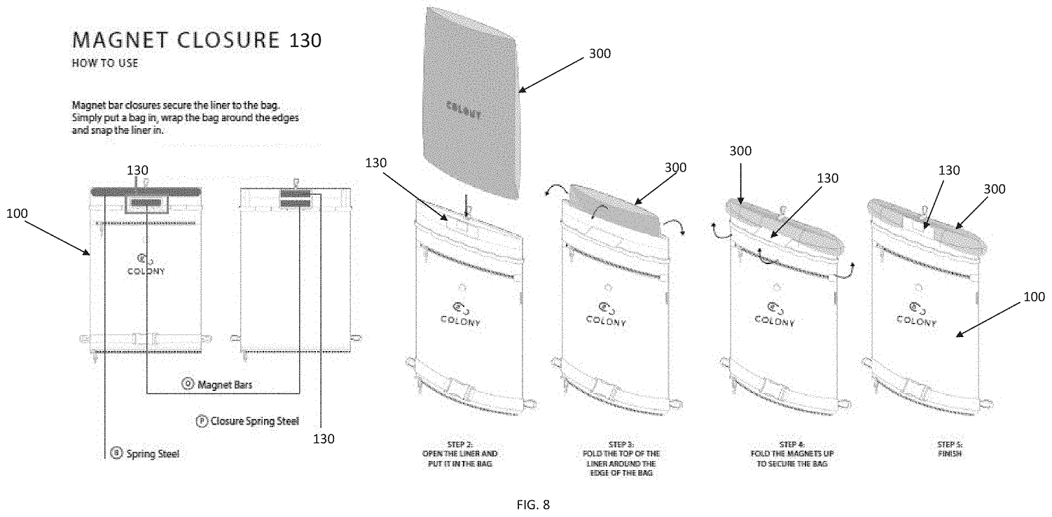

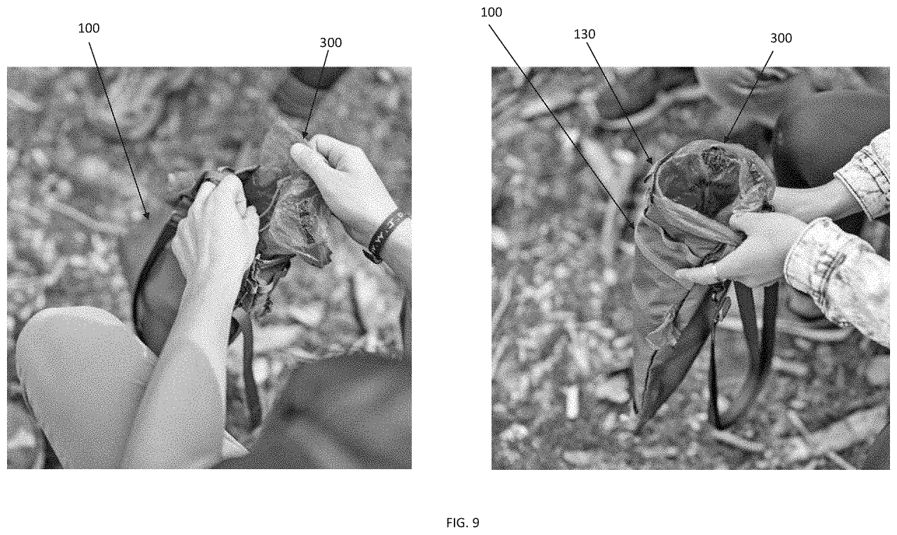

Referring to FIG. 8, the portable container 100 can further comprise a garbage and waste liner securement mechanism 130 disposed proximate the top opening 110. The garbage and waste liner securement mechanism 130 can include a magnetic liner securement mechanism as illustrated in FIG. 8. The magnetic liner securement mechanism 130 can include one or more foldable fabric flaps containing a magnetic and/or metallic element(s). Installation of a liner within the portable container is illustrated in FIG. 9, wherein the liner 300 is placed within an interior of the portable container 100 and un upper portion of the liner 300 is disposed over an upper edge of the portable container 100. The flexible tabs of the waste liner securement mechanism 130 are disposed over the end of the liner 300 and secured via the internal magnets.

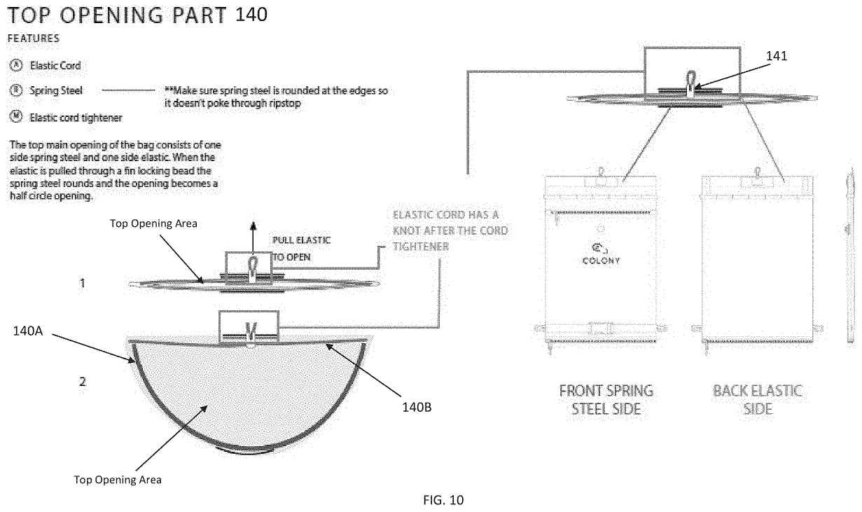

The portable container 100 can further include a top opening expansion retention mechanism 140 as illustrated in FIG. 10. The top opening expansion retention mechanism 140 can include a spring 140A and a tensioner 140B. The spring 140A can include a substantially flat spring in an untensioned state. The tensioner 140B can include a cord coupled to opposing ends of the spring 140B. A reduced effective length between opposing ends of the tensioner 140B can cause the spring 140A to bend and retain an increased two dimensional top end opening area for placement of the garbage and waste within the sidewalls of the portable container as illustrated in FIGS. 9 and 10. The portable container 100 can including a lockable fitting 141 configured to reduce an effective length of the tensioner 140B between connected ends of the spring 140A.

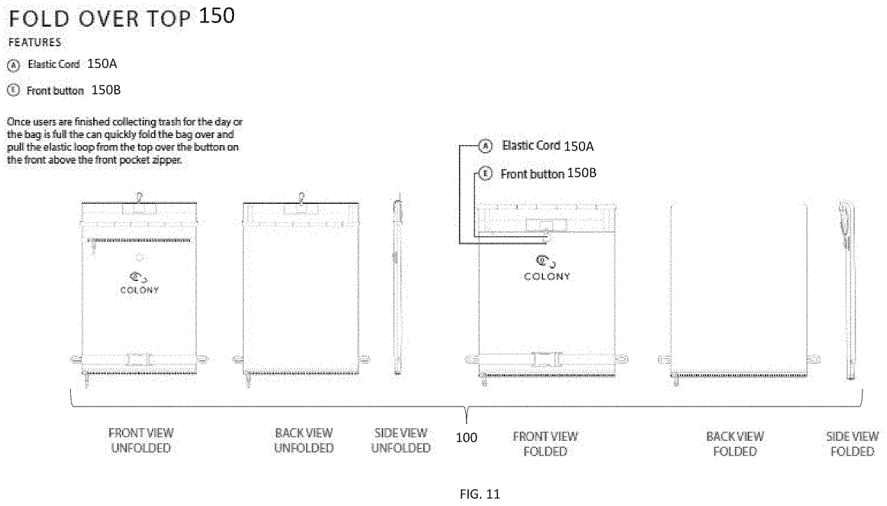

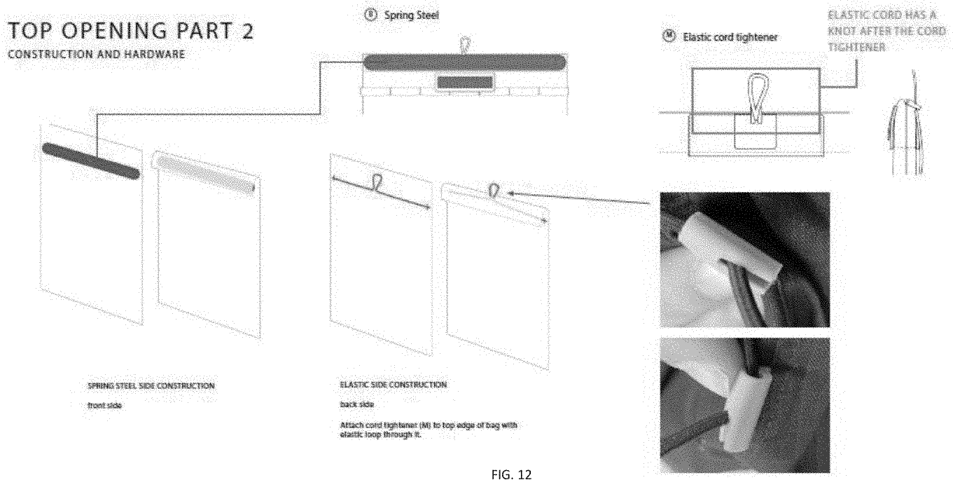

The portable container can further include a roll-top closure mechanism 150 as illustrated in FIGS. 11 and 12. The roll-top closure mechanism 150 can include a loop 150A disposed on a cord and a front button 150B coupled to an exterior of a sidewall of the portable container 100 so as to fold the top of the portable container 100 thereby further securing the top opening in a closed position.

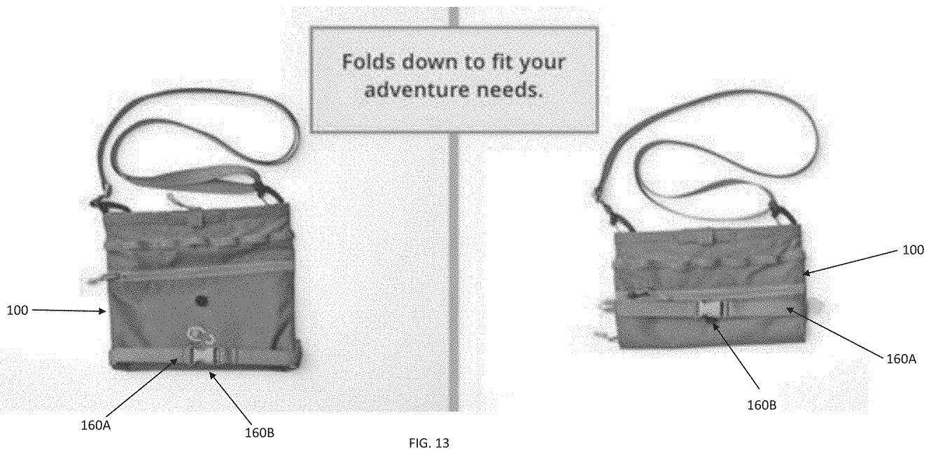

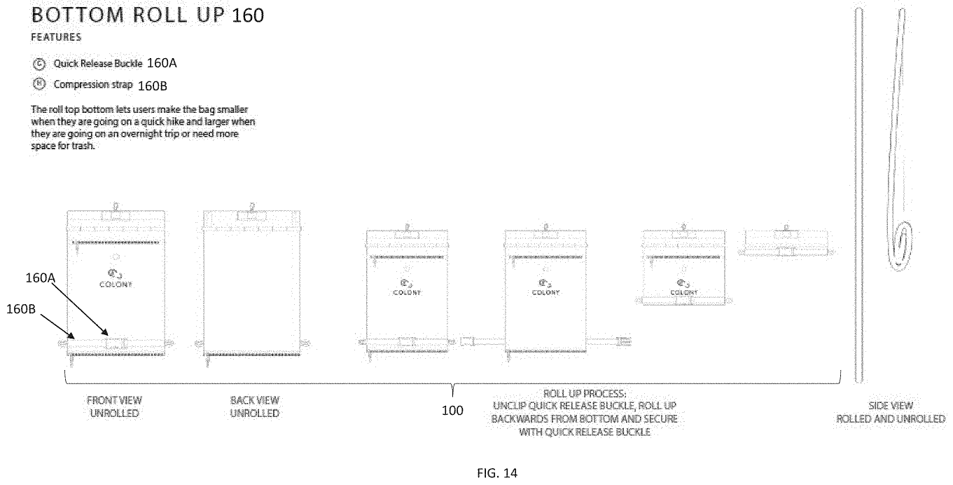

Referring to FIGS. 13 and 14, a roll-bottom retention mechanism 160 is illustrated. The roll-bottom retention mechanism 160 can include a strap 160B and buckle 160A for retaining a rolled-bottom configuration of the portable container 100 so as to reduce an effective size of the portable container 100.

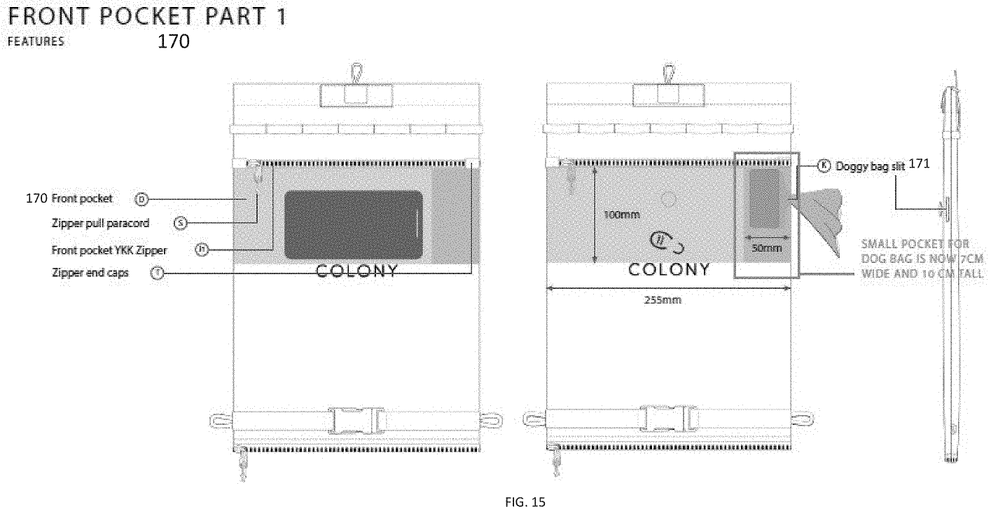

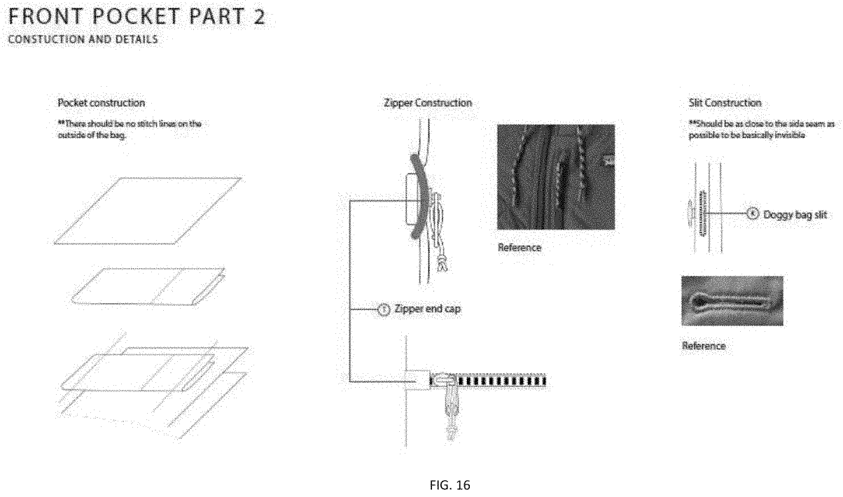

Referring to FIGS. 15 and 16, the portable container 100 can further include a moisture impervious front pocket 170 including an opening having a moisture impervious zipper closure mechanism for holding items and extra garbage and waste liners. The front pocket 170 can further include a liner access opening 171 and compartment for accessing garbage and waste liners stored therein.

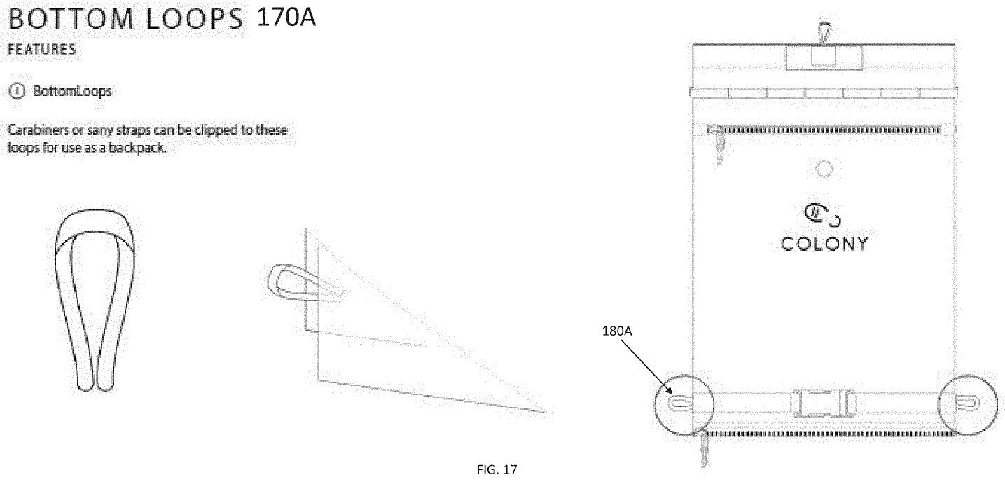

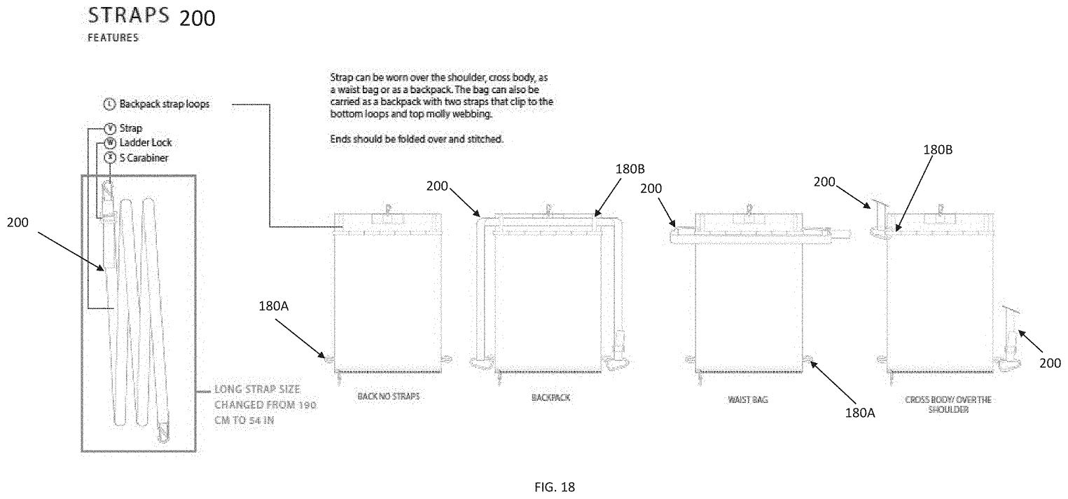

Referring to FIGS. 17 and 18, the portable container 100 can include one or more container strap connectors 180 coupled to the portable container 100 for connecting the portable container 100 to one or more straps 200 for carrying the portable container 100. The portable container 100 can include two side container strap connectors 180A coupled to opposing sidewalls of the portable container. The portable container can include a top container strap connector 180B coupled to a top of the portable container. The portable container 100 can further include the one or more straps 200 including strap connectors for connecting each strap 200 to the container strap connectors 180.

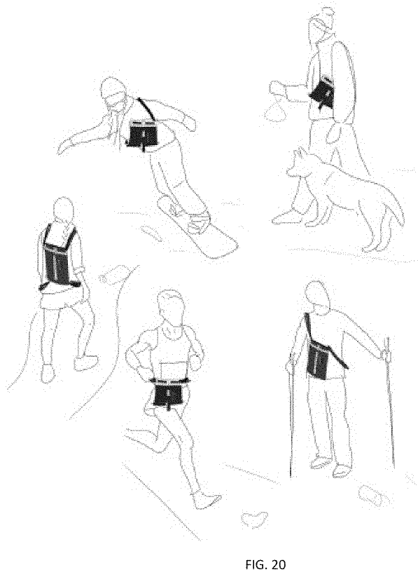

The straps 200 can be connectable to the portable container 100 so as to carry the portable container 100 in a backpack configuration, a waistline carrying configuration, a cross-body, over-the-shoulder, and/or handle carrying configuration as illustrated in FIG. 20.

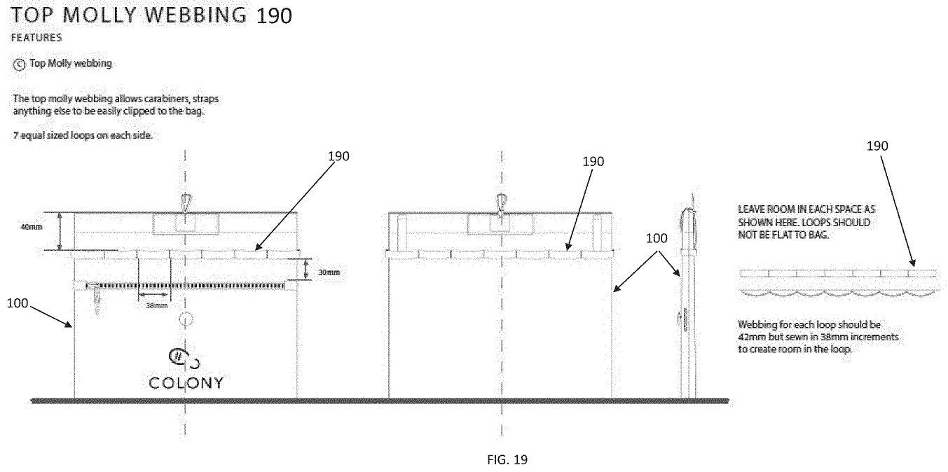

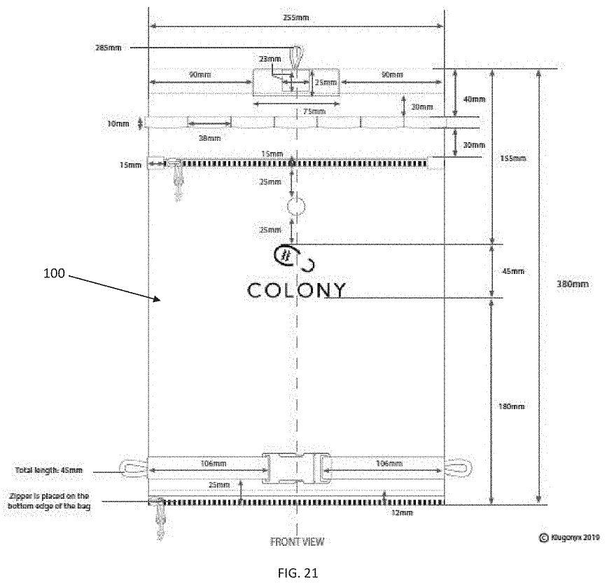

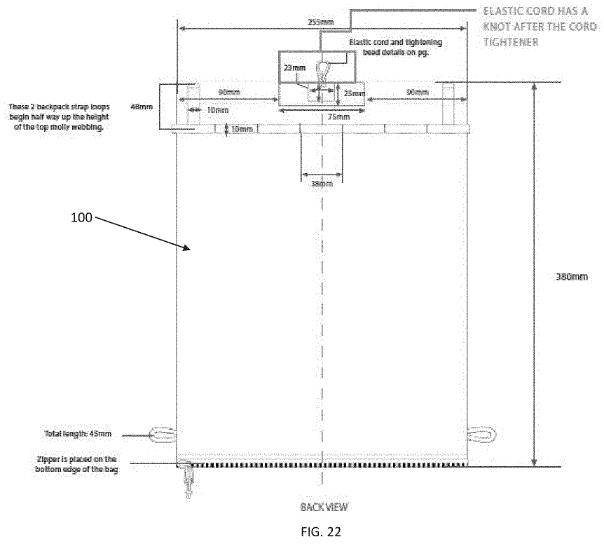

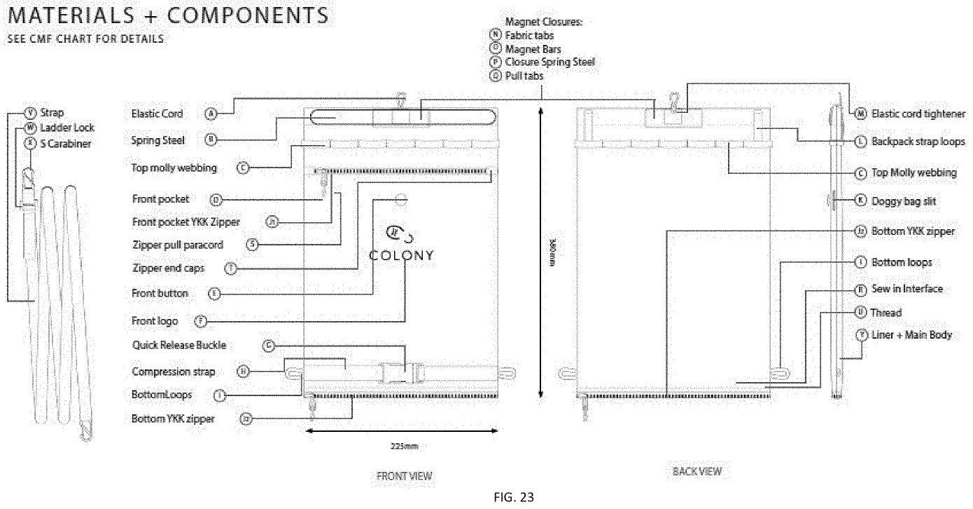

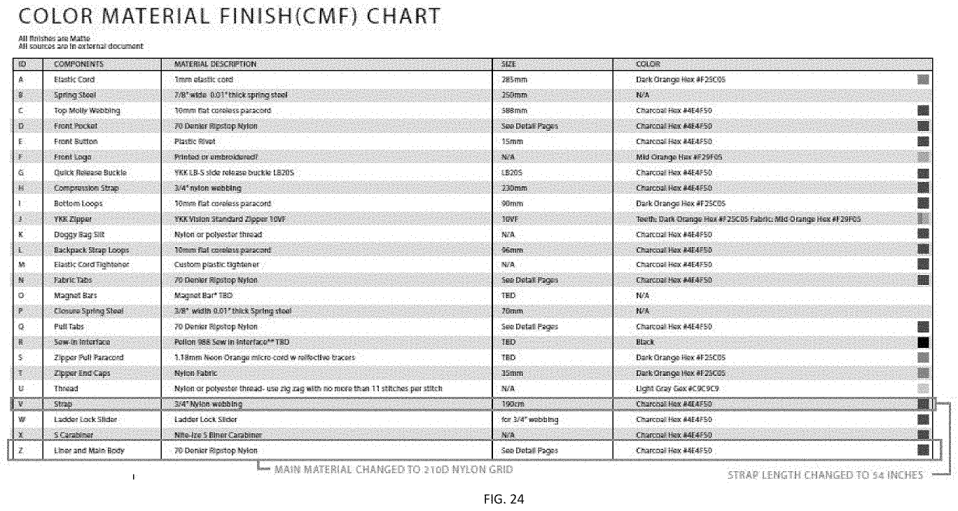

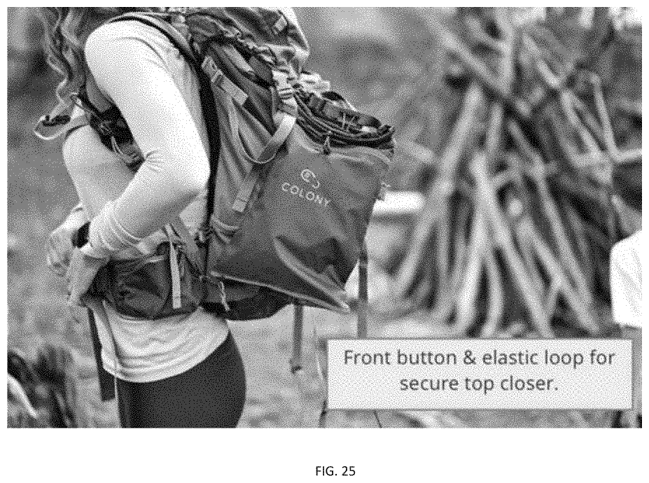

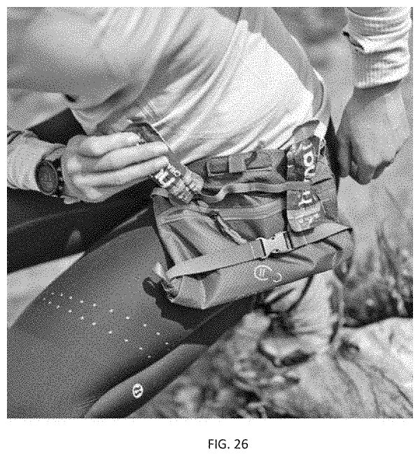

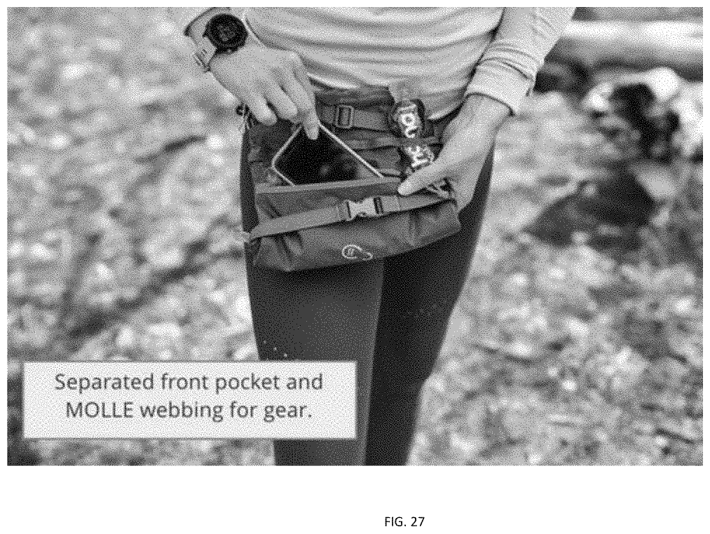

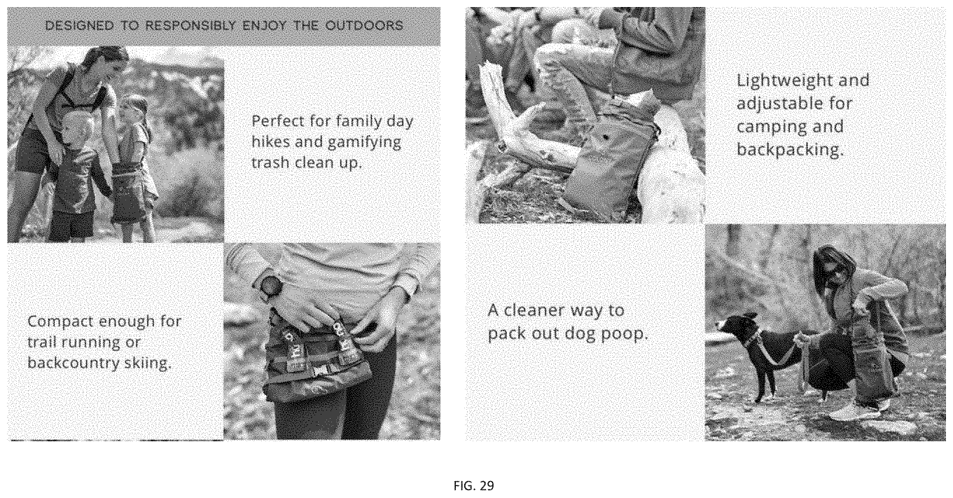

FIGS. 21 and 22 illustrate some examples of dimensions which may be suitable for components and aspects of the portable container 100. FIGS. 23 and 24 illustrate examples of various materials and components that may be part of the portable container 100 according to various preferred embodiments. And, FIGS. 25-29 show uses and advantages of the portable container 100 along with uses of the Molly webbing 190 extending around a periphery of the portable container 100 as illustrated in FIG. 19.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It is understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, quadrants, thirds, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A portable container for collecting and disposing of garbage and waste, comprising:
container sidewalls including a flexible moisture impervious fabric for containing and holding the garbage and waste when placed therein;
a top opening;
a top closure mechanism for selective placement of the garbage and waste within the sidewalls of the portable container;
a bottom opening; and
a bottom closure mechanism disposed proximate to the bottom opening and enabling selective gravity enabled disposal of the garbage and waste from the bottom of the portable container.

2. The portable container according to claim 1, the bottom closure mechanism including a zipper extending across the bottom opening, the zipper being substantially moisture impervious when disposed in a zipped and closed configuration.

3. The portable container according to claim 1, the top closure mechanism including a magnetic closure mechanism.

4. The portable container according to claim 3, the magnetic closure mechanism including opposing magnetic elements and/or opposing magnetic and metallic elements.

5. The portable container according to claim 1, further comprising a garbage and waste liner securement mechanism disposed proximate the top opening.

6. The portable container according to claim 5, the garbage and waste liner securement mechanism including a magnetic liner securement mechanism.

7. The portable container according to claim 6, the magnetic liner securement mechanism including one or more foldable fabric flaps containing a magnetic and/or metallic element.

8. The portable container according to claim 1, further comprising a top opening expansion retention mechanism.

9. The portable container according to claim 8, the top opening expansion retention mechanism including a spring and a tensioner.

10. The portable container according to claim 9, the spring being a substantially flat spring in an untensioned state.

11. The portable container according to claim 10, the tensioner including a cord coupled to opposing ends of the spring.

12. The portable container according to claim 11, wherein reduced effective length between opposing ends of the tensioner causes the spring to bend and retain an increased two dimensional top end opening area for placement of the garbage and waste within the sidewalls of the portable container.

13. The portable container according to claim 10, the tensioner including a lockable fitting configured to reduce an effective length of the tensioner between connected ends of the spring.

14. The portable container according to claim 1, portable container further comprising roll-top closure mechanism.

15. The portable container according to claim 14, the roll-top closure mechanism including a loop disposed on a cord and button coupled to an exterior of a sidewall of the portable container so as to fold the top of the portable container thereby further securing the top opening in a closed position.

16. The portable container according to claim 1, further comprising a roll-bottom retention mechanism.

17. The portable container according to claim 16, the roll-bottom retention mechanism comprising a strap and buckle for retaining a rolled-bottom configuration of the portable container so as to reduce an effective size of the portable container.

18. The portable container according to claim 1, further comprising a moisture impervious front pocket including an opening having a moisture impervious zipper closure mechanism for holding items and extra garbage and waste liners.

19. The portable container according to claim 18, the front pocket further comprising a liner access opening and compartment for accessing garbage and waste liners stored therein.

20. The portable container according to claim 1, further comprising one or more container strap connectors coupled to the portable container for connecting the portable container to one or more straps for carrying the portable container.

21. The portable container according to claim 20, the portable container including two side container strap connectors coupled to opposing sidewalls of the portable container.

22. The portable container according to claim 21, further comprising a top container strap connector coupled to a top of the portable container.

23. The portable container according to claim 22, further comprising one or more straps including strap connectors for connecting to the container strap connectors.

24. The portable container according to claim 23, the straps being connectable to the portable container so as to carry the portable container in a backpack configuration, a waistline carrying configuration, a cross-body, over-the-shoulder, and/or handle carrying configuration.

25. The portable container according to claim 1, further comprising a Molly webbing disposed proximate the top opening.
